(19) United States
(12) Patent Application Publication
(10) Pub. No.: US 2012/0298008 A1
(43) Pub. Date: Nov. 29, 2012

(54) DIELECTRIC THIN FILM FOR LOW TEMPERATURE PROCESS AND METHOD FOR MANUFACTURING THE SAME

(75) Inventors: Ji Won CHOI, Seoul (KR); Seok Jin YOON, Seoul (KR); Jin Sang KIM, Seoul (KR); Chong Yun KANG, Seoul (KR); Ho Won JANG, Seoul (KR); Yun Hoe KIM, Seoul (KR)

(73) Assignee: KOREA INSTITUTE OF SCIENCE AND TECHNOLOGY, Seoul (KR)

(21) Appl. No.: 13/190,131

(22) Filed: Jul. 25, 2011

(30) Foreign Application Priority Data
May 24, 2011 (KR) 10-2011-0048804

(51) Int. Cl. C09D 1/00; B05D 3/02

(52) U.S. Cl. 106/286.2; 427/372.2

(57) ABSTRACT

Provided are a dielectric thin film and a method for manufacturing the same. The dielectric thin film has a composition represented by the formula of TaₓMg₁₋ₓO, wherein 0.082≦x≦0.89. The dielectric thin film provides excellent dielectric characteristics. Particularly, the dielectric thin film provides a high relative permittivity as well as low dielectric loss and leakage current, although it is formed (deposited) at a low temperature of 350° C. or lower (between room temperature and 350° C.).

### CROSS-REFERENCE TO RELATED APPLICATION

This application claims priority to Korean Patent Application No. 10-2011-0048804, filed on May 24, 2011, and all the benefits accruing therefrom under 35 U.S.C. §119, the contents of which in its entirety are herein incorporated by reference.

### BACKGROUND

1. Field

The present disclosure relates to a dielectric thin film and a method for manufacturing the same. More particularly, the present disclosure relates to a dielectric thin film including tantalum oxide (Ta₂O₅) and magnesium oxide (MgO) in a specific ratio and having a high dielectric permittivity (high dielectric constant) and low dielectric loss and leakage current, as well as to a method for manufacturing the same.

2. Description of the Related Art

As we are truly entering the era of ubiquitous computing, some components, such as dielectric thin films, forming various electric/electronic devices are mounted to a high density to provide compact and highly integrated devices. To provide such compact and highly integrated devices, dielectric thin films tend to have a decreased thickness and area. However, decreasing the thickness and area of a dielectric thin film may cause an insufficient capacitance, resulting in soft errors by which information stored by a device is changed. Recently, in order to maintain a minimum charge capacity required for a device to perform stable operation by preventing such soft errors, many studies have been conducted to develop novel dielectric thin films having a high dielectric constant instead of decreasing the thicknesses or areas of dielectric thin films.

In general, dielectric thin films are obtained by using ceramic materials (metal oxides). Particularly, when manufacturing dielectric thin films, sintering processes are essential, and the materials are annealed at a high temperature of several hundreds Celsius degrees up to several thousands Celsius degrees to increase the densities, to realize characteristics as ceramic materials, and to maintain the shapes. However, such high temperature sintering processes cause the ceramic materials to undergo shrinking of about at least 13%, thereby inducing severe problems in complicated patterns on three-dimensional (3D) structures and alignment of via-holes, or the like. In addition, since sintering processes are carried out at high temperatures, materials decomposed by high temperatures, such as polymers, have difficulty in bonding among themselves. Therefore, there is a need for methods for manufacturing dielectric thin films at low temperatures.

In general, high-dielectric constant materials, including calcium-doped Pb(ZrₓTi₁₋ₓ)O₃, (BaₓSr₁₋ₓ)TiO₃, Ta₂O₅, Al₂O₃—Ta₂O₅ and Y₂O₃, have been used to provide compact and highly integrated devices. The above-mentioned materials show high capacitance densities, and thus satisfy the requirement for capacitance. However, they are subjected to an excessively high temperature of 400° C. or higher during the manufacture (deposition), and above all, they show very high dielectric loss and leakage current, both of which are most important in terms of dielectric characteristics. In particular, in order to apply dielectric thin films to such devices as metal-insulator-metal (MIM) capacitors or gate insulators of flexible thin film transistors, it is required for them to provide a high dielectric constant (high relative permittivity) as well as low dielectric loss and leakage current. In addition, it is required for them to allow formation at a low processing temperature below 400° C. In other words, even if the materials are formed at a low temperature below 400° C., it is required for them to have dielectric characteristics.

However, dielectric thin films according to the related art provide insufficient relative permittivity, dielectric loss and leakage current, or require high processing temperatures. For example, in the case of calcium-doped Pb(ZrₓTi₁₋ₓ)O₃ and (BaₓSr₁₋ₓ)TiO₃ thin films, sufficient relative permittivity is provided but a high processing temperature is required. In addition, (BaₓSr₁₋ₓ)TiO₃ and Ta₂O₅ thin films deposited at room temperature undesirably show a low relative permittivity and high dielectric loss.

### SUMMARY

The present disclosure is directed to providing a dielectric thin film including tantalum oxide (Ta₂O₅) and magnesium oxide (MgO) in a specific ratio, and shows a high dielectric constant (high relative permittivity) as well as low dielectric loss and leakage current despite its formation at a low temperature. The present disclosure is also directed to providing a method for manufacturing the dielectric thin film.

In one aspect, there is provided a dielectric thin film having a composition represented by the formula of TaₓMg₁₋ₓO, wherein 0.082 5≦x≦0.89.

In another aspect, there is provided a method for manufacturing a dielectric thin film, including depositing a thin film having a composition represented by the formula of TaₓMg₁₋ₓO, wherein 0.082≦x≦50.89, at a deposition temperature between room temperature and 350° C.

The method may further include annealing the deposited thin film at a temperature higher than the deposition temperature. The annealing may be carried out at 300-380° C.

In addition, in the above formula, x may be a number satisfying 0.80≦x≦0.89.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a graph showing the results of evaluation of dielectric constants and dielectric losses in the dielectric thin films obtained in accordance with an embodiment, before annealing (deposition at room temperature) and after annealing (annealing at 350° C. after the deposition at room temperature); and

FIG. 2 is a graph showing the results of evaluation of leakage current densities in the dielectric thin films obtained in accordance with an embodiment, before annealing (deposition at room temperature) and after annealing (annealing at 350° C. after the deposition at room temperature).

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As mentioned earlier, in order to apply dielectric thin films to such devices as metal-insulator-metal (MIM) capacitors or gate insulators of flexible thin film transistors, it is required for them to allow formation at low temperatures (low-temperature processes) and to provide a high relative permittivity as well as low dielectric loss and leakage current.

We have conducted many studies about the materials and compositions of dielectric thin films using tantalum oxide (Ta₂O₅) and magnesium oxide (MgO) by investigating the compositions through a continuous composition spreading method. After the studies, we have found that a specific composition that is not disclosed by the related art not only provides a thickness sufficient to prevent electron tunneling but also shows a high relative permittivity (high dielectric constant) and very low dielectric loss and leakage current. The present disclosure is based on this finding.

As used herein, the term ‘room temperature’ means ambient temperature and may be a temperature ranging from 5° C. to 35° C. In addition, the term ‘continuous composition spreading method’ means a method including depositing, on one substrate, thin films having different compositions continuously at different positions of the substrate to allow investigation of the compositions in a short time. We have investigated a desired composition of dielectric thin film having excellent dielectric characteristics through the above-mentioned continuous composition spreading method.

Particularly, independent sputter guns oriented at 90° to the substrate are used. Herein, a tantalum oxide (Ta₂O₅) target and a magnesium oxide (MgO) target are mounted to each sputter gun and subjected to sputtering continuously to one substrate, so that the characteristics of the deposited oxides are evaluated as a function of position on the substrate. In this manner, a desired composition having excellent dielectric characteristics is investigated. As the result of such investigation, it can be seen that when tantalum oxide (Ta₂O₅) and a magnesium oxide (MgO) are doped (substituted) in a specific compositional ratio (molar fraction), a thin film has excellent dielectric characteristics even if it is deposited at a low temperature (from room temperature to 350° C.). In other words, the thin film has dielectric characteristics including a high relative permittivity (dielectric constant) as well as very low dielectric loss and leakage current.

The dielectric thin film disclosed herein is a tantalum-magnesium oxide (TMO) thin film containing tantalum (Ta) and magnesium (Mg) and has a composition represented by the formula of TaₓMg₁₋ₓO.

In the above formula, 0.082≦x≦0.89. In the above formula, x is a molar fraction (i.e., molar fraction of Ta) and values of x beyond the above defined range (0.082≦x≦0.89) may not provide excellent dielectric characteristics. More particularly, when x is less than 0.082, relative permittivity (dielectric constant) is decreased and dielectric loss and leakage current are increased. On the other hand, when x is greater than 0.89, relative permittivity (dielectric constant) may be increased but dielectric loss is increased.

More particularly, x may satisfy the condition of 0.12≦x≦0.89. The dielectric thin film has better dielectric characteristics in such a range (0.12≦x≦0.89). For example, in the above-defined range, the dielectric thin film has a dielectric constant of 10 or more and a dielectric loss (tan δ) of 0.02 or less. More specifically, x may satisfy the condition of 0.35≦x≦0.50. In the above-defined specific range (0.35≦x≦0.50), the dielectric thin film has a dielectric constant of 15 or more and a dielectric loss (tan δ) of 0.01 or less.

Any dielectric thin film (TMO thin film) is included in the dielectric thin film disclosed herein, as long as it has the composition as defined above. The dielectric thin film may be formed by a deposition process at a low temperature of 350° C. or lower, and more particularly, between room temperature and 350° C. Even when the dielectric thin film having the above-defined composition is deposited and formed by such a low-temperature process, it has excellent dielectric characteristics. When carrying out low-temperature deposition, magnesium oxide (MgO) may be added (doped) to tantalum oxide (Ta₂O₅), or vice versa.

According to an embodiment, the dielectric thin film disclosed herein may be further subjected to annealing at a temperature higher than the deposition temperature, after carrying out deposition at low temperature so as to provide a composition represented by the above formula. When carrying out such annealing, the dielectric thin film may have better dielectric characteristics. The annealing may be carried out at a temperature below 400° C. More particularly, deposition may be carried out at a low temperature of 350° C. or lower, and then annealing may be carried out at 300-380° C.

In the above formula, x may satisfy the condition of 0.80≦x≦0.89. Particularly, the dielectric thin film may be deposited at a low temperature (between room temperature and 350° C.) so as to satisfy the condition of 0.80≦x≦0.89, and then subjected to annealing at 300-380° C. In this manner, It is possible to obtain a high dielectric constant (high permittivity) of 25 or higher, specifically a very high dielectric constant of about 29. In addition, it is also possible to obtain a low dielectric loss (tan δ) of 0.01 or less, specifically a very low dielectric loss (tan δ) of about 0.004. Further, it is possible to obtain very low leakage current. According to a particular embodiment, the dielectric thin film may be deposited at room temperature, and then subjected to annealing at 300-380° C., for example, at 350° C.

As mentioned above, the compositional ratio is investigated by a continuous composition spreading method. Particularly, sputter guns charged with tantalum oxide (Ta₂O₅) and magnesium oxide (MgO) are used to deposit the oxides on a substrate through a sputtering system at a low temperature (e.g. room temperature), wherein the oxides are deposited continuously with different compositions at different positions on the substrate. Then, the characteristics of the deposited oxide films (TMO thin films) are evaluated as a function of position on the substrate. As the result of such evaluation, it can be seen that when Ta is present at a specific ratio (molar fraction) corresponding to 0.082≦x≦0.89, it is possible to obtain excellent dielectric characteristics.

In addition, when carrying out annealing at a higher temperature than the deposition temperature after the low-temperature deposition (e.g. deposition at room temperature), the resultant dielectric thin film has better dielectric characteristics. In particular, when the ratio (molar fraction) of Ta corresponds to 0.80≦x≦0.89, such annealing provides a high relative permittivity (dielectric constant) as well as very low dielectric loss and leakage current.

In another aspect, a method for manufacturing the dielectric thin film disclosed herein includes depositing the dielectric thin film (TMO thin film) having a composition represented by the above formula. In other words, the method includes depositing the dielectric thin film in such a manner that x satisfies the condition of 0.082≦x≦0.89, particularly 0.12≦x≦0.89, and more particularly 0.35≦x≦0.50.

There is no particular limitation in methods for carrying out deposition. For example, at least one method selected from sputtering, physical vapor deposition (PVD), chemical vapor deposition (CVD), pulsed laser deposition (PLD), electron beam evaporation, atomic layer deposition (ALD) and molecular beam epitaxy (MBE), etc. may be used. Particularly, sputtering, such as RF sputtering or DC sputtering, may be used. In addition, the deposition is carried out at a low temperature of 350° C. or lower, particularly a temperature between room temperature and 350° C.

When carrying out the deposition, the dielectric thin film (TMO thin film) may be deposited on a substrate. There is no particular limitation in the substrate, as long as the substrate may support the dielectric thin film (TMO thin film). For example, the substrate may be selected from metal substrates, ceramic substrates, semiconductor substrates, polymer substrates, etc. Flexible substrates may also be used. As used herein, flexible substrates include any substrates having flexibility and may be selected from flexible polymer films, thin metal films, etc. In addition, the dielectric thin film (TMO thin film) may be deposited directly on a component forming a device. For example, the dielectric thin film may be deposited directly on a substrate forming a device, such as a MIM capacitor or transistor, or a component (e.g. electrode) forming a device.

Any deposition processes may be used as long as they allow the dielectric thin film (TMO thin film) to have a composition represented by the above formula. For example, the deposition may be carried out to provide a composition represented by the above formula by taking a TMO oxide (TaₓMg₁₋ₓO, 0.082≦x≦0.89) as a target. In addition, tantalum oxide (Ta₂O₅) and magnesium oxide (MgO) are used as targets and each of them is mounted to a sputter gun. Then, the oxides are subjected to sputtering at the same time to allow the dielectric thin film to have a composition represented by the above formula. Herein, the distance between a substrate and a sputter gun, i.e., between a substrate and each target (Ta₂O₅, MgO), or the RF or DC powder of a sputtering system may be controlled to adjust the molar fractions of Ta and Mg so that the dielectric thin film has a composition represented by the above formula. For example, when the Ta₂O₅ target is positioned in such a manner that it has a shorter distance from the substrate than the MgO target, it is possible to increase the molar fraction (x value) of Ta.

In addition, the method for manufacturing the dielectric thin film disclosed herein may further include carrying out annealing after carrying out the deposition. In other words, annealing may be performed after the deposition is carried out at a temperature between room temperature and 350° C. Although there is no limitation, annealing may be carried out in an electric furnace or microwave oven. Particularly, annealing may be carried out at a temperature higher than the deposition temperature (between room temperature and 350° C.). As described above, such annealing subsequent to the deposition may provide better dielectric characteristics. More particularly, annealing may be carried out at a temperature below 400° C. In an embodiment wherein the dielectric thin film is applied to MIM capacitors or flexible devices, annealing may be carried out at 300-380° C. When the annealing temperature is lower than 300° C., it is not possible to improve dielectric characteristics to a sufficient degree. On the other hand, when the annealing temperature is higher than 380° C., it may adversely affect the device, such as MIM capacitor or flexible thin film transistor, or cause thermal deformation of a flexible substrate (e.g. polymer substrate).

Further, as described above, annealing provides a better effect under the condition of 0.80≦x≦0.89. Particularly, the method for manufacturing the dielectric thin film disclosed herein may include: depositing a dielectric thin film (TMO thin film) at a low temperature (between room temperature and 350° C.) to satisfy the condition of 0.80≦x≦0.89; and carrying out annealing of the deposited dielectric thin film (TMO thin film) at a temperature higher than the deposition temperature, i.e. 300-380° C. Under these conditions, it is possible to provide a very high relative permittivity (dielectric constant) as well as very low dielectric loss and leakage current.

As can be seen from the foregoing, the dielectric thin film having the specific composition as represented by the above formula provides excellent dielectric characteristics. In other words, despite the low-temperature (between room temperature and 350° C.) deposition, it is possible to obtain a high relative permittivity (high dielectric constant) as well as very low dielectric loss and leakage current.

The dielectric thin film (TMO thin film) disclosed herein may be useful for various electric/electronic devices as a dielectric film. Although there is no particular limitation in the field of application, the dielectric thin film (TMO thin film), having a high relative permittivity (high dielectric constant) as well as very low dielectric loss and leakage current even at a low processing temperature, is particularly useful as a functional dielectric thin film, such as a capacitor thin film for wafer level packing; MIM capacitor in a very large scale integration back-end of line (VLSI-BEOL) process; and a gate insulator of a flexible thin film transistor.

### EXAMPLES

The examples and experiments will now be described. The following examples and experiments are for illustrative purposes only and not intended to limit the scope of the present disclosure.

### Example

In this Example, Ta₂O₅ thin films doped with MgO (TMO thin films: TaₓMg₁₋ₓO) are deposit on a substrate with different compositions. Next, 500 kinds of MIM capacitor devices are manufactured by using 500 upper electrodes. Then, the dielectric constant, dielectric loss and leakage current density of each device having a different composition are evaluated.

First, an off-axis RF sputtering system having sputter guns arranged at 90° is used to deposit the TMO thin films having a size of 75×25 mm (width×length) onto a silicon wafer coated with a platinum (Pt) layer. Particularly, each of the sputter guns charged with Ta₂O₅ targets and MgO targets are arranged in perpendicular to the silicon wafer (Pt coating) while maintaining an angle of 90° between each sputter gun and the wafer, and then deposition is accomplished by carrying out sputtering using the sputter guns charged with Ta₂O₅ targets at 100 W power and the sputter guns charged with MgO targets at 150 W power. The deposition is carried out in a mixed gas of argon with oxygen (Ar+O₂) under a pressure of 20 mTorr at room temperature for 30 minutes. Herein, the distance between the silicon wafer (Pt coating) and each sputter gun is controlled to obtain a composition with a different molar fraction of Ta (x in the formula of TaₓMg₁₋ₓO).

Then, in order to determine the dielectric characteristics of each deposited TMO thin film having a different composition, a Pt electrode having a thickness of 200 nm and an area of 4.0×10⁻⁴ cm² is deposited on the TMO thin films through DC sputter deposition, thereby providing specimens of capacitor devices with MIM structures.

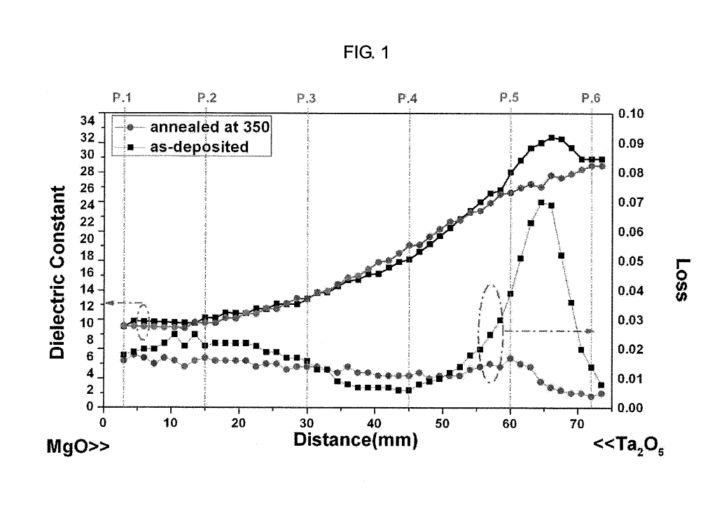

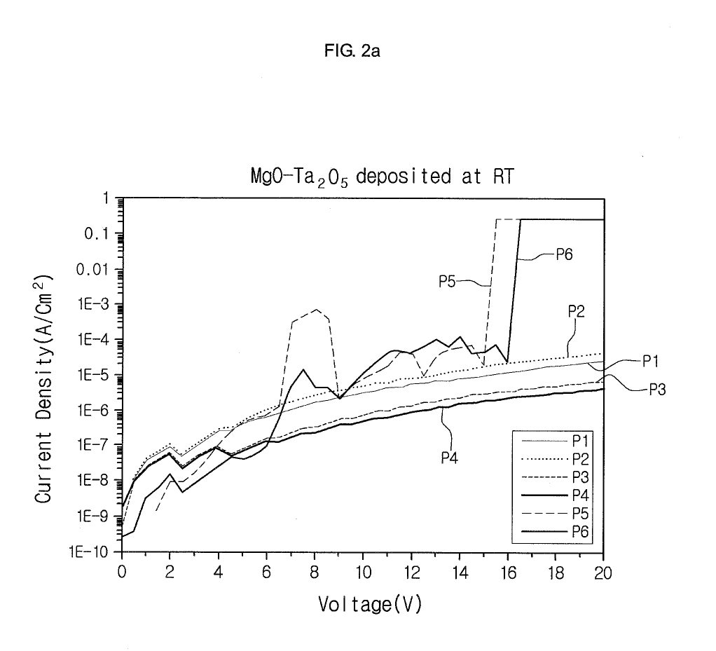

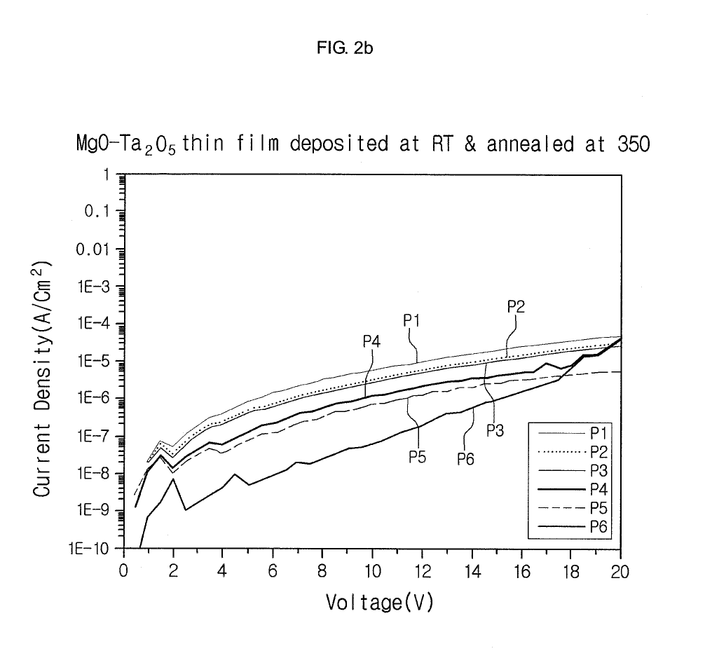

In addition, the dielectric constant, dielectric loss and leakage current density of each specimen having a different composition is determined by using an automated probe station. The results are shown in FIG. 1 and FIG. 2. Herein, the dielectric loss is expressed as loss tangent (tan δ) measured at a frequency of 1 MHz.

Further, TMO thin films are deposited in the same manner as described above, and then subjected to annealing in an electric furnace at 350° C. for 30 minutes. The heat-treated TMO thins films are used to provide capacitor device specimens having different compositions in the same manner as described above. Then, the dielectric characteristics of the annealed specimens are determined and the results are shown in FIG. 1 and FIG. 2.

FIG. 1 is a graph showing the results of evaluation of dielectric constants and dielectric losses in the dielectric thin films obtained in accordance with an embodiment, before annealing (deposition at room temperature) and after annealing (annealing at 350° C. after the deposition at room temperature). In FIG. 1, the upper two graphs show the results of evaluation of dielectric constants before and after the annealing, while the lower two graphs show the results of evaluation of dielectric losses before and after the annealing.

FIG. 2 is a graph showing the results of evaluation of leakage current densities of the compositions corresponding to the lines (P.1-P.6) as shown in FIG. 1. Herein, portion (a) of FIG. 2 shows leakage current densities before the annealing (deposition at room temperature), while portion (b) of FIG. 2 shows leakage current densities after the annealing (annealing at 350° C. after the deposition at room temperature).

The following Table 1 and Table 2 show the dielectric constants and dielectric losses (tan δ) of a representative part of the compositions as shown in FIG. 1. More particularly, Table 1 shows the results of evaluation of TMO thin films before annealing (deposition at room temperature deposition), while Table 2 shows the results of evaluation of TMO thin films after annealing (annealing at 350° C. after deposition at room temperature).

TABLE 1
Results of evaluation of dielectric characteristics of TMO thin
films deposited at room temperature

| x | Dielectric loss | Dielectric |
|---|---|---|
| (molar fraction) | (tan δ) | constant |
| 0.076 | — | 9.6 |
| 0.082 | 0.018 | 9.7 |
| 0.12 | 0.021 | 10.7 |
| 0.19 | 0.016 | 13.0 |
| 0.38 | 0.006 | 17.7 |
| 0.52 | 0.011 | 22.1 |
| 0.80 | 0.039 | 28.1 |
| 0.83 | 0.014 | 29.6 |
| 0.92 | — | 29.9 |

TABLE 2
Results of evaluation of dielectric characteristics of TMO thin films
annealed at 350° C. after deposited at room temperature

| x | Dielectric loss | Dielectric |
|---|---|---|
| (molar fraction) | (tan δ) | constant |
| 0.076 | — | 9.5 |
| 0.082 | 0.016 | 9.8 |
| 0.12 | 0.017 | 10.1 |
| 0.19 | 0.014 | 13.0 |
| 0.38 | 0.011 | 19.4 |
| 0.80 | 0.017 | 25.6 |
| 0.83 | 0.004 | 28.8 |
| 0.89 | 0.012 | 29.5 |
| 0.92 | — | 29.5 |

As can be seen from FIG. 1 and Tables 1 and 2, the TMO thin films have dielectric constants and dielectric losses varying with the molar fraction of Ta (x in TaₓMg₁₋ₓO). Particularly, the room temperature-deposited TMO thin films show a sufficient dielectric constant (relative permittivity) ranging from 9.7 to 29.6 and a low dielectric loss of 0.006-0.039 over the whole range of compositions (0.082≦x≦0.89). In addition, in the case of room temperature deposition, better dielectric characteristics are provided when 0.35≦x≦0.50. Particularly, when Ta₂O₅ has a molar fraction of 0.38 (x=0.38), a very low dielectric loss of 0.006 and a high dielectric constant of about 18 are provided.

In addition, in the case of room temperature deposition followed by annealing at 350° C. for 5 minutes, an increase in molar fraction of Ta₂O₅ from 0.082 to 0.83 causes a linear increase in dielectric constant from 9.8 to 28.8. Particularly, when the molar fraction of Ta₂O₅ is 0.83, a very low dielectric loss of 0.004 and a very high dielectric constant of about 29 are provided. Although the TMO thin film itself has a very low dielectric loss of 0.004, it may have a more decreased dielectric loss by controlling the deposition condition or post-treatment, when considering the report that dielectric loss may be decreased from 0.02 to 0.01 by controlling texturing, interface, stress or surface roughness in a dielectric thin film.

In addition, as can be seen from FIG. 2, the TMO thin films with compositions in specific regions (e.g. line P.3 and P.4 regions in FIG. 1) provide a relatively low leakage current density. When comparing portion (a) with portion (b) in FIG. 2, portion (b) subjected to annealing at 350° C. shows a lower leakage current density. Particularly, the lowest leakage current density is provided when x=0.83.

As can be seen from the above results, the most optimized result is obtained when Ta₂O₅ doped with 0.17 moles of MgO is deposited and then the resultant dielectric thin film is annealed at 350° C. In other words, when the dielectric thin film is deposited in such a manner that it has a composition of Ta_{0.83}Mg_{0.17}O (x=0.83 in TaₓMg₁₋ₓO) and then further annealed at 350° C., it is possible to obtain a very high dielectric constant of 29 as well as very low dielectric loss of 0.004 and leakage current density of 10⁻⁷ A/cm² (applied voltage: 10V or less).

As can be seen from the foregoing Example, the dielectric thin film having a composition of TaₓMg₁₋ₓO (wherein x, molar fraction of Ta, satisfies the condition of 0.082≦x≦0.89) through the addition (doping) of MgO to Ta₂O₅ or addition (doping) of Ta₂O₅ to MgO provides good dielectric characteristics. In addition, when annealing is carried out after the deposition, it is possible to provide excellent dielectric characteristics in a specific range of composition (x=0.83).

As described above, the dielectric thin film having the specific composition as represented by the above formula has excellent dielectric characteristics. Particularly, even though the dielectric thin film is formed (deposited) at a low temperature of 350° C. or lower (between room temperature and 350° C.), it has a very high relative permittivity (high dielectric constant) while providing very low dielectric loss and leakage current.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A dielectric thin film having a composition represented by the formula of TaₓMg₁₋ₓO, wherein 0.082≦x≦0.89.

2. The dielectric thin film according to claim 1, wherein 0.35≦x≦0.50 or 0.80≦x≦0.89.

3. The dielectric thin film according to claim 1, which is deposited at a temperature between room temperature and 350° C.

4. The dielectric thin film according to claim 1, which is deposited at a temperature between room temperature and 350° C., and then annealed at a temperature higher than the deposition temperature.

5. The dielectric thin film according to claim 4, which is annealed at 300-380° C.

6. The dielectric thin film according to claim 2, which is deposited at a temperature between room temperature and 350° C.

7. The dielectric thin film according to claim 2, which is deposited at a temperature between room temperature and 350° C., and then annealed at a temperature higher than the deposition temperature.

8. The dielectric thin film according to claim 7, which is annealed at 300-380° C.

9. A method for manufacturing a dielectric thin film, which comprises depositing a thin film having a composition represented by the formula of TaₓMg₁₋ₓO, wherein 0.082≦x≦0.89, at a deposition temperature between room temperature and 350° C.

10. The method for manufacturing a dielectric thin film according to claim 9, wherein 0.35≦x≦0.50 or 0.80≦x≦0.89.

11. The method for manufacturing a dielectric thin film according to claim 9, which further comprises carrying out annealing of the deposited thin film at a temperature higher than the deposition temperature.

12. The method for manufacturing a dielectric thin film according to claim 11, wherein the deposited thin film is annealed at 300-380° C.

13. The method for manufacturing a dielectric thin film according to claim 10, which further comprises carrying out annealing of the deposited thin film at a temperature higher than the deposition temperature.

14. The method for manufacturing a dielectric thin film according to claim 13, wherein the deposited thin film is annealed at 300-380° C.
